(19) United States
(12) Patent Application Publication
(10) Pub. No.: US 2013/0304680 A1
(43) Pub. Date: Nov. 14, 2013

(54) PREDICTIVE CORROSION COUPONS FROM DATA MINING

(71) Applicants: Richard S. Bailey, Surrey (GB); Kip P. Sprague, Anchorage, AK (US); Eric Ziegel, Houston, TX (US)

(72) Inventors: Richard S. Bailey, Surrey (GB); Kip P. Sprague, Anchorage, AK (US); Eric Ziegel, Houston, TX (US)

(73) Assignees: BP EXPLORATION OPERATING COMPANY LIMITED, Sunbury-On-Thames (GB); BP CORPORATION NORTH AMERICA INC., Houston, TX (US)

(21) Appl. No.: 13/468,585

(22) Filed: May 10, 2012

(51) Int. Cl. G06N 5/02; G06N 3/02

(52) U.S. Cl. 706/15; 706/46

(57) ABSTRACT

In accordance with aspects of the present disclosure, a computer-implemented method for predicting a material deterioration of a coupon inserted into the well line system is disclosed. The computer-implemented method can be stored on a tangible and non-transitory computer readable medium and arranged to be executed by one or more processors that cause the one or more processors to receive data related to the well line system; determine one or more predictors of material deterioration of a coupon based on the data; and predict a material deterioration of the coupon inserted into the well line system based on a mathematical model of the material deterioration using the one or more predictors.

### CROSS-REFERENCE TO RELATED APPLICATIONS

This application claims benefit of patent application Serial No. PCT/US12/37060 filed May 9, 2012, and entitled “Predictive Corrosion Coupons From Data Mining,” which is hereby incorporated herein by reference in its entirety.

### STATEMENT REGARDING FEDERALLY SPONSORED RESEARCH OR DEVELOPMENT

Not applicable.

### BACKGROUND

This disclosure is in the field of pipeline inspection, and is more specifically directed to a model to predict corrosion and/or pitting rates for a coupon within a pipeline.

Typically, a section of a pipeline contains one or more physical coupons arranged within to provide a measure of corrosion activity experienced by an interior surface of the pipeline. These physical coupons are made of a material that is the same or similar to the material that the internal surface of the pipeline is made and are arranged to be extracted from the pipeline periodically for inspection, removal and replacement with a new coupon. The inspection must be performed manually, which means that a technician may be exposed to hostile environments to which the pipeline is exposed, as well as to the materials being transported by the pipeline. Because oil and gas reservoirs are increasingly being processed in extreme environments, such as the North Slope in Alaska, the pipelines that support them are also subject to these conditions. Moreover, the materials being transported by the pipeline are usually under extreme temperatures and pressures, which may also be hazardous to the on-site technician.

For example, for the almost 3000 pipelines in the North Slope, new coupons are typically inserted and subsequently removed 2-3 times per year. The results from the coupon inspections are principally used to plan the amount of chemical inhibition that is needed for the pipeline. The data for corrosion rate, pitting rate, and maximum pit depth constitute a portion of the data that is maintained for all the inspections of the pipelines.

Maintaining the integrity of pipelines is a fundamental function in maintaining the economic success and minimizing the environmental impact of oil and gas production fields and systems. In addition, pipeline integrity is also of concern in other applications, including factory piping systems, municipal water and sewer systems, and the like. Similar concerns exist in the context of other applications, such as production casing of oil and gas wells. As is known in the field of pipeline maintenance, corrosion and ablation of pipeline material, from the fluids flowing through the pipeline, will reduce the thickness of pipeline walls over time. In order to prevent pipeline failure, it is of course important to monitor the extent to which pipeline wall thickness has been reduced, so that timely repairs can be made.

An improved method for determining/estimating the rate of corrosion and pitting in pipelines is desired to reduce unnecessary risks to inspectors of pipeline coupons.

### BRIEF SUMMARY

In accordance with some aspects of the present disclosure, a computer-implemented method for predicting a material deterioration of a coupon inserted into a well line system is disclosed. The method can be implemented as a computer application or program that can be stored on a tangible and non-transitory computer readable medium and arranged to be executed by one or more processors that cause the one or more processors to receive historical and current data related to the well line system; determine one or more relevant predictors of a corrosion rate, pit depth and/or pitting rate of a coupon based on the historical and current data; and predict the material deterioration of a coupon inserted into the well line system based on a mathematical model of corrosion activity using the one or more predictors.

In some aspects, the computer-implemented method can further comprise creating the mathematical model of corrosion activity using the one or more predictors.

In some aspects, the mathematical model can include a logistic regression or a neural network.

In some aspects, the predictions can be based on production conditions, historical results and the well characteristics for a particular pipeline that is being evaluated by the coupons.

In some aspects, the predictions can be made periodically or continuously.

In some aspects, the method can further comprise causing the one or more processors to fit the mathematical model to determine a best-fitting model for the one or more predictors.

In some aspects, the data can include one or more categorical and/or one or more numerical variables.

In some aspects, the categorical variables can include a pad name, a well subset, a date of first inhibition treatment, gas-lifted well, drive, zones, metallurgy, treatment intensity, roles varied and a production zone.

In some aspects, the data can include quantitative predictors.

In some aspects, the quantitative predictors can include predictors that were computed for each coupon period including oil production, gas production, water production, a lift gas, a wellhead temperature, a wellhead pressure, a liquid space velocity and a gas space velocity.

In some aspects, the quantitative predictors can include an average, a maximum and an inter-quartile range for the data.

In some aspects, the data can include predictors used to represent periods during which the coupon was being used in the pipeline including estimated CO₂, time since the last inhibition treatment, number of shut-ins for the well, duration of time in which the coupon was in the pipeline, percentage of working hours for the well and fraction.

In some aspects, the data can include quantitative variables representing well-to-well differences including the span, the cumulative oil production across the life of the well, the cumulative gas production across the life of the well, the cumulative water production across the life of the well and the cumulative lift gas used across the life of the well.

In some aspects, the neural network can include a multi-layer perceptron, wherein the multi-layer percepteron can include a nonlinear prediction equation.

In some aspects, the one or more predictors can be determined by determining a correlation between the data. The one or more relevant predictors can be determined if the correlation is greater than a correlation threshold.

In some aspects, the material deterioration can include corrosion activity, pit depth and/or pitting rate.

In accordance with some aspects of the present disclosure, a prediction system for predicting a material deterioration of a coupon inserted into a well line system is disclosed. The system can include one or more central processing units for executing program instructions; and a memory, coupled to the central processing unit, for storing a computer program including program instructions that, when executed by the one or more central processing units, is capable of causing the computer system to perform a sequence of operations for predicting a corrosion rate, pit depth and/or pitting rate of a coupon inserted into the well line system. The sequence of operations can comprise receiving data related to the well line system; determining one or more predictors of the material deterioration of the coupon based on the data; and predicting the material deterioration of the coupon inserted into the well line system based on a mathematical model of the material deterioration using the one or more predictors. In some aspects, the material deterioration can include corrosion activity, pit depth and/or pitting rate.

In accordance with some aspects of the present disclosure, a computer-readable medium is disclosed that can be stored as a computer program that, when executed on a computer system, causes the computer system to perform a sequence of operations for predicting a material deterioration of a coupon inserted into the well line system, the sequence of operations comprising: receive data related to the well line system; determine one or more predictors of the material deterioration of the coupon based on the data; and predict the material deterioration of the coupon inserted into the well line system based on a mathematical model of material deterioration using the one or more predictors. In some aspects, the material deterioration can include corrosion activity, pit depth and/or pitting rate.

In accordance with some aspects of the present disclosure, a computer-implemented method for predicting a material deterioration of a coupon inserted into the well line system is disclosed. The method can comprise receiving data related to the well line system; predicting, by a processor, the material deterioration of the coupon inserted into the well line system based on a mathematical model of material deterioration using one or more predictors; and applying the material deterioration predicted to schedule an inspection time on the well line system.

### BRIEF DESCRIPTION OF THE SEVERAL VIEWS OF THE DRAWING

FIG. 1 is a schematic diagram of an example of a production field in connection with which the embodiments of the disclosure may be used.

FIG. 2 is an exemplary diagram, in block form, of an evaluation system programmed to carry out an embodiment of the disclosure.

FIG. 3 is a flow diagram illustrating an example method for numerical data and statistical/computation model according to an embodiment of the disclosure.

FIG. 4 shows exemplary plots for the histograms for average wellhead temperature, average liquid space velocity (Av.liqvel), average gas space velocity (Av.gasvel) and maximum wellhead temperature according to an embodiment of the disclosure.

FIG. 5 shows exemplary plots for the logarithms of the distributions for the average and maximum for the liquid and gas space velocities according to an embodiment of the disclosure.

FIG. 6 shows an exemplary neural network model diagram according to an embodiment of the disclosure.

FIG. 7 shows an exemplary table listing the expected correlations from the training data for the fit of the neural network model according to an embodiment of the disclosure.

FIG. 8 shows an exemplary table listing the expected correlations from the validation data (logarithm of corrosion rate) for the neural network model according to an embodiment of the disclosure.

FIG. 9 shows a partial exemplary table listing for the set of predictions that may be made for the observed data (l.corrate) according to an embodiment of the disclosure.

FIG. 10 shows an exemplary table listing the statistics for a validation set according to an embodiment of the disclosure.

FIG. 11 shows an exemplary table listing the relationship (correlation) between the mean, maximum and IQR for oil and water predictors according to an embodiment of the disclosure.

FIG. 12 shows an exemplary table listing the relationship (correlation) between oil, water, space velocity for the liquid (vsl), gas and space velocity of the gas (vsg) predictors according to an embodiment of the disclosure.

FIG. 13 shows an exemplary table listing statistics according to an embodiment of the disclosure.

FIG. 14 shows an exemplary table listing the data for some of the predictors and the prediction according to an embodiment of the disclosure.

FIG. 15 shows an exemplary table listing the linear/non-linear effects in the neural network for various predictors according to an embodiment of the disclosure.

FIG. 16 shows an exemplary plot of the linear/non-linear effects of gas production according to an embodiment of the disclosure.

FIG. 17 shows an exemplary plot of the linear/non-linear effects of liquid space velocity according to an embodiment of the disclosure.

FIG. 18 shows an exemplary plot of the prediction of the different well treatment years according to an embodiment of the disclosure.

FIG. 19 shows an exemplary plot of the actual responses log (corrosion rate) values versus the model's response values for the training data according to an embodiment of the disclosure.

FIG. 20 shows an exemplary plot of a residuals Q-Q versus a normal distribution according to an embodiment of the disclosure.

FIG. 21 shows an exemplary plot for the residuals versus the gas production values for the training data according to an embodiment of the disclosure.

FIG. 22 shows an exemplary plot of the residuals versus average lift gas for a coupon period according to an embodiment of the disclosure.

FIG. 23 shows an exemplary plot of the residuals versus the year in which the coupons were pulled according to an embodiment of the disclosure.

FIG. 24 shows an example of the box plots of the residuals versus the well identification code according to an embodiment of the disclosure.

FIG. 25 shows an example of the box plot of residuals of the coupons in their 11 groups by year of the pull according to an embodiment of the disclosure.

FIG. 26 shows an example of a normal Q-Q plot for the logs of the within well variances according to an embodiment of the disclosure.

FIG. 27 shows an exemplary plot of the number of coupons with pitting according to an embodiment of the disclosure.

FIG. 28 shows an exemplary table for validation data for predictions of a correct classification of a pitting according to an embodiment of the disclosure.

FIG. 29 shows an exemplary table for validation data used for predictions of a correct classification of pitting from a classification neural network according to an embodiment of the disclosure.

FIG. 30 shows an exemplary plot of an impact of oil production on the probability of a “yes” classification for pitting according to an embodiment of the disclosure.

FIG. 31 shows in an exemplary table for the likelihood of correct classification resulting from the fitting of the validation data to the model according to an embodiment of the disclosure.

FIG. 32 shows in another exemplary table for the likelihood of correct classification resulting from the fitting of the validation data to the model according to an embodiment of the disclosure.

FIG. 33 shows an exemplary table showing the impact of predictors on the classification for a neural network according to an embodiment of the disclosure.

FIG. 34 shows an exemplary plot showing the effect of gas production on pitting according to an embodiment of the disclosure.

FIG. 35 shows another exemplary table for the likelihood of correct classification of additional coupons collected subsequent to the modeling according to an embodiment of the disclosure.

FIG. 36 shows an exemplary table of predictions for pitting depth according to an embodiment of the disclosure.

### DETAILED DESCRIPTION

The present disclosure will be described in connection with its embodiments a method and system for monitoring and evaluating pipeline integrity in a production field and system for oil and gas. However, it is contemplated that this disclosure can also provide important benefits in other applications, including the monitoring and evaluating of production casing integrity in oil and gas wells, and the monitoring and evaluating of pipeline integrity in other applications such as water and sewer systems, natural gas distribution systems on the customer side, and factory piping systems, to name a few. Accordingly, it is to be understood that the following description is provided by way of example only, and is not intended to limit the true scope of this disclosure as claimed.

In the description below, specific examples are given for data that was acquired for pipelines from the North Slope of Alaska, where there are several hundred flow lines and more than 2000 well lines for which coupon measurement is available. In particular, examples below are taken from a field that is primarily not managed with large amounts of chemical inhibition.

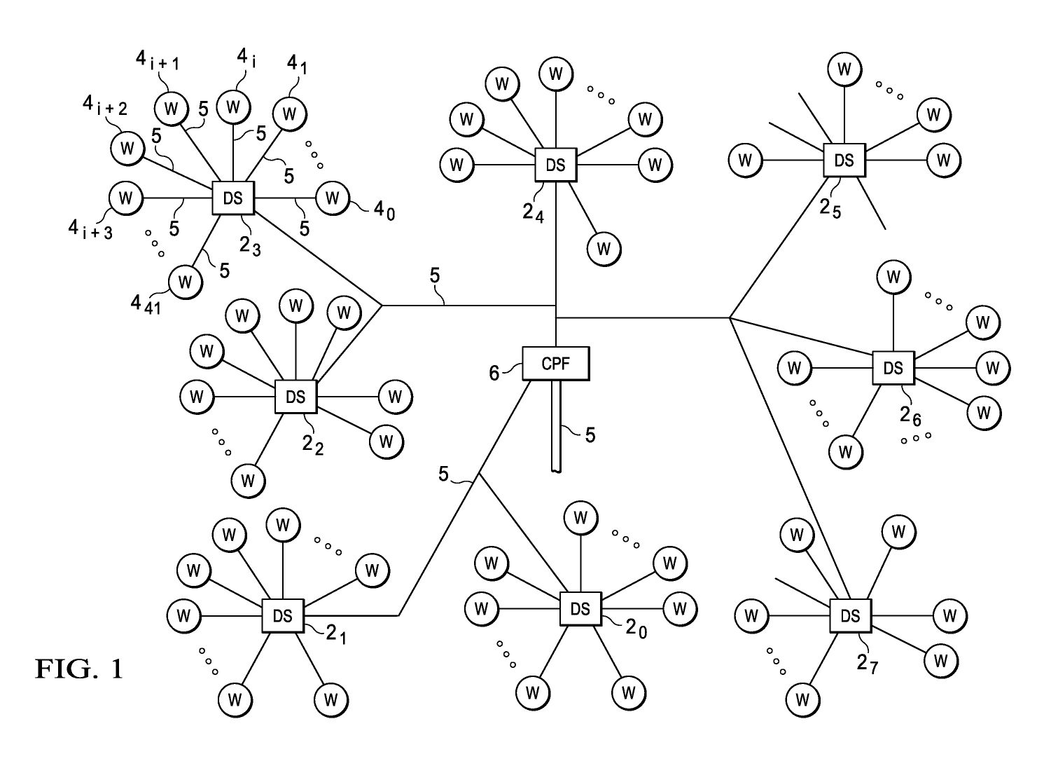

Referring first to FIG. 1, an example of an oil and gas production field, including surface facilities, in connection with which an embodiment of the disclosure can be utilized, is illustrated in a simplified block form. In this example, the production field includes multiple wells 4, deployed at various locations within the field, from which oil and gas products are to be produced in the conventional manner. While a number of wells 4 are illustrated in FIG. 1, it is contemplated that modern production fields in connection with which the present disclosure can be utilized will include many more wells than those wells 4 depicted in FIG. 1. In this example, each well 4 can be connected to an associated one of multiple drill sites 2 in its locale by way of a pipeline 5. By way of example, eight drill sites 2₀ through 2₇ are illustrated in FIG. 1; it is, of course, understood by those in the art that more or less than eight drill sites 2 can be deployed within a production field. Each drill site 2 can support wells 4; for example drill site 2₃ is illustrated in FIG. 1 as supporting forty-two wells 4₀ through 4₄₁. Each drill site 2 gathers the output from its associated wells 4, and forwards the gathered output to central processing facility 6 via one of pipelines 5. Eventually, central processing facility 6 can be coupled into an output pipeline 5, which in turn can be coupled into a larger-scale pipeline facility along with other central processing facilities 6.

In the example of oil production from the North Slope of Alaska, the pipeline system partially shown in FIG. 1 connects into the Trans-Alaska Pipeline System, along with many other wells 4, drilling sites 2, pipelines 5, and processing facilities 6. Thousands of individual pipelines can be interconnected in the overall production and processing system connecting into the Trans-Alaska Pipeline System. As such, the pipeline system illustrated in FIG. 1 can represent only a portion of an overall production pipeline system.

While not suggested by the schematic diagram of FIG. 1, in actuality pipelines vary widely from one another in construction and geometry, in parameters including diameter, nominal wall thickness, overall length, numbers and angles of elbows and curvature, location (underground, above-ground, or extent of either placement), to name a few. In addition, parameters regarding the fluid carried by the various pipelines 5 also can vary widely in composition, pressure, flow rate, and the like. These variations among pipeline construction, geometry, contents, and nominal operating condition can affect the extent and nature of corrosion and ablation of the pipeline walls, as known in the art. In addition, it has been observed, in connection with this disclosure, that the distribution of wall loss (i.e., wall thickness loss) measurements along pipeline length also varies widely among pipelines in an overall production field, with no readily discernible causal pattern relative to construction or fluid parameters.

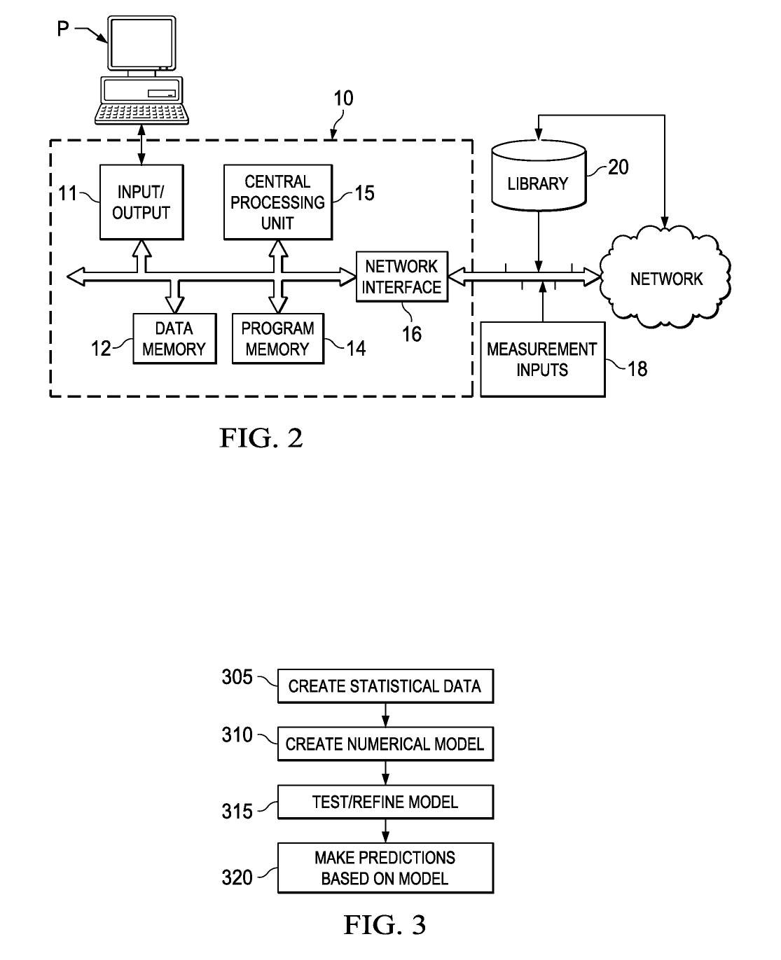

FIG. 2 illustrates the configuration of prediction system 10 according to an example of an embodiment of the disclosure, as realized by way of a computer system. Prediction system 10 performs the operations described in this specification to determine a corrosion rate, pit depth and/or pitting rate of a coupon inserted into the well line system. Of course, the particular architecture and construction of a computer system useful in connection with this disclosure can vary widely. For example, prediction system 10 can be realized by a computer based on a single physical computer, or alternatively by a computer system implemented in a distributed manner over multiple physical computers. Accordingly, the architecture illustrated in FIG. 2 is provided merely by way of example.

As shown in FIG. 2, prediction system 10 can include central processing unit 15, coupled to system bus “BUS”. Input/output interface 11 can also be coupled to system BUS, which refers to those interface resources by way of which peripheral functions P (e.g., keyboard, mouse, display, etc.) interface with the other constituents of prediction system 10. Central processing unit 15 refers to the data processing capability of prediction system 10, and as such can be implemented by one or more CPU cores, co-processing circuitry, and the like. The particular construction and capability of central processing unit 15 can be selected according to the application needs of prediction system 10; such needs including, at a minimum, the carrying out of the functions described in this specification, and also including such other functions as may be desired to be executed by a computer system. In the architecture of prediction system 10 according to this example, data memory 12 and program memory 14 can be coupled to system BUS, and can provide memory resources of the desired type useful for their particular functions. Data memory 12 can store input data and the results of processing executed by central processing unit 15, while program memory 14 can store the computer instructions to be executed by central processing unit 15 in carrying out those functions. Of course, this memory arrangement is only an example, it being understood that data memory 12 and program memory 14 can be combined into a single memory resource, or distributed in whole or in part outside of the particular computer system shown in FIG. 1 as implementing prediction system 10. Typically, data memory 12 can be realized, at least in part, by high-speed random-access memory in close temporal proximity to central processing unit 15. Program memory 14 can be realized by mass storage or random access memory resources in the conventional manner, or alternatively can be accessible over network interface 16 (i.e., if central processing unit 15 is executing a web-based or other remote application).

Network interface 16 can be a conventional interface or adapter by way of which prediction system 10 accesses network resources on a network. As shown in FIG. 2, the network resources to which prediction system 10 has access via network interface 16 can include those resources on a local area network, as well as those accessible through a wide-area network such as an intranet, a virtual private network, or over the Internet. In this embodiment of the disclosure, sources of data processed by prediction system 10 are available over such networks, via network interface 16. Library 20 can store historical and/or current data or measurements for selected pipelines in the overall production field or pipeline system; library 20 can reside on a local area network, or alternatively can be accessible via the Internet or some other wider area network. It is contemplated that library 20 can also be accessible to other computers associated with the operator of the particular pipeline system. In addition, as shown in FIG. 2, measurement inputs 18 for other pipelines in the production field or pipeline system can be stored in a memory resource accessible to prediction system 10, either locally or via network interface 16.

Of course, the particular memory resource or location in which the measurements 18 can be stored, or in which library 20 can reside, can be implemented in various locations accessible to prediction system 10. For example, these data can be stored in local memory resources within prediction system 10, or in network-accessible memory resources as shown in FIG. 2. In addition, these data sources can be distributed among multiple locations, as known in the art. Further in the alternative, the measurements corresponding to measurements 18 and to library 20 can be input into prediction system 10, for example by way of an embedded data file in a message or other communications stream. It is contemplated that those skilled in the art will be able to implement the storage and retrieval of measurements 18 and library 20 in a suitable manner for each particular application.

According to this embodiment of the disclosure, as mentioned above, program memory 14 can store computer instructions executable by central processing unit 15 to carry out the functions described in this specification, by way of which measurements 18 for a given pipeline are analyzed to determine and/or predict a particular level of coupon corrosion or pitting in the pipeline. These computer instructions can be in the form of one or more executable programs, or in the form of source code or higher-level code from which one or more executable programs are derived, assembled, interpreted or compiled. Any one of a number of computer languages or protocols can be used, depending on the manner in which the desired operations are to be carried out. For example, these computer instructions can be written in a conventional high level language, either as a conventional linear computer program or arranged for execution in an object-oriented manner. These instructions can also be embedded within a higher-level application. It is contemplated that those skilled in the art having reference to this description will be readily able to realize, without undue experimentation, this embodiment of the disclosure in a suitable manner for the desired installations. Alternatively, these computer-executable software instructions can, according to the preferred embodiment of the disclosure, be resident elsewhere on the local area network or wide area network, accessible to prediction system 10 via its network interface 16 (for example in the form of a web-based application), or these software instructions can be communicated to prediction system 10 by way of encoded information on an electromagnetic carrier signal via some other interface or input/output device.

In general, a virtual or soft coupon is described that can make an estimate of a coupon's weight loss, interpreted as ‘corrosion rate’ and also ‘pitting rate’ based on the same aggregated processing conditions as are used for assessing whether inspection locations are active. By monitoring the predicted result for the virtual coupon it will be possible to provide the evidence to encourage the inspection teams to pull the real coupon earlier or later than some typical nominal time period. Because evidence has been generated that coupons that are left in the line for longer periods of time show a marked improvement in ability to accurately foretell corrosion rates as determined by a repeat inspection the benefits of the ‘virtual coupon’ are that the Heath, Safety, Security, and the Environment (HSSE) risk associated with working on pipelines carrying pressurized fluids (potentially also toxic and/or flammable) and the cost of pulling and analyzing coupons can be reduced by leaving coupons in the pipeline for longer. Also, the average accuracy of the coupons will improve as the average exposure time is increased.

The virtual or soft coupon can allow use of a whole dataset across all the asset's (or even multiple assets') pipeline infrastructures to be effectively included in the predicted corrosion assessment. To make effective use of this much larger quantity of pipe inspection data, corrosion coupon results and production history can be used to establish a predictive ‘virtual coupon’ model of coupon response. A predictive model of the rate of wall loss response for the pipe can be constructed, either from just the aggregated coupons and the pipe's condition and corrosion activity immediately prior to the current inspection period, or from the aggregated coupons together with aggregated production data, or based just on the aggregated production data. The disclosure includes techniques to ensure adequate weighting of periods of corrosion activity relative to the majority data, which naturally corresponds to inactive corrosion periods, as well as techniques for segregating the data resource into learning and validation sets.

The virtual or soft coupon uses a mathematical model to predict the corrosion rate, pit depth, and pitting rate that would be expected for an actual coupon that has been inserted into the pipeline. The predictions can be based on production conditions, historical results, and the well characteristics for the particular pipeline that is being evaluated by the coupons. The predictions can be made on a daily basis, if that is desirable, or summaries of expected coupon performance to date can be obtained periodically. There are benefits from this approach including an up-to-date evaluation of the current corrosion rate expectations for the pipeline that can be obtained without removing the coupons. This timeliness ensures that situations for which the risk to pipeline integrity has increased will be detected quickly. Moreover, cost reductions will occur, and Heath, Safety, Security, and the Environment (HSSE) benefits will accrue, because coupons for which there is not expectation of significant corrosion or pitting will not need to be pulled by a regular schedule. They can simply be left in the pipeline until there is some indication from the production and operational environment for the pipeline that some corrosion has occurred and has been measured with the coupon.

The predictive model will be described in terms of a modeling using a neural network; however, this embodiment is merely exemplary and is not intended to limit the disclosure. Other types of modeling methods can be used, for example, linear or logistic regression models.

FIG. 3 illustrates an exemplary method for the predictive model in accordance with aspects of the present disclosure. By way of a non-limiting example, the model can be created by first preparing the data at 305. The data can be filtered to account for data sets that are missing data. For example, data for production flow (oil, water, gas and gas lift) may not also be available from the wells. Moreover, for instances where data exists for a pair of coupons, the corrosion and pitting data can be averaged across the coupon pair.

In order to predict the presence of corrosion activity in a well line system, data such as production history, oil, gas and water flows, processing pressure and temperature, coupon insertion and pull dates and measured corrosion and pitting rates during their exposure periods, repeated inspection results which record inspection location, pipe condition and corrosion activity present can be collected.

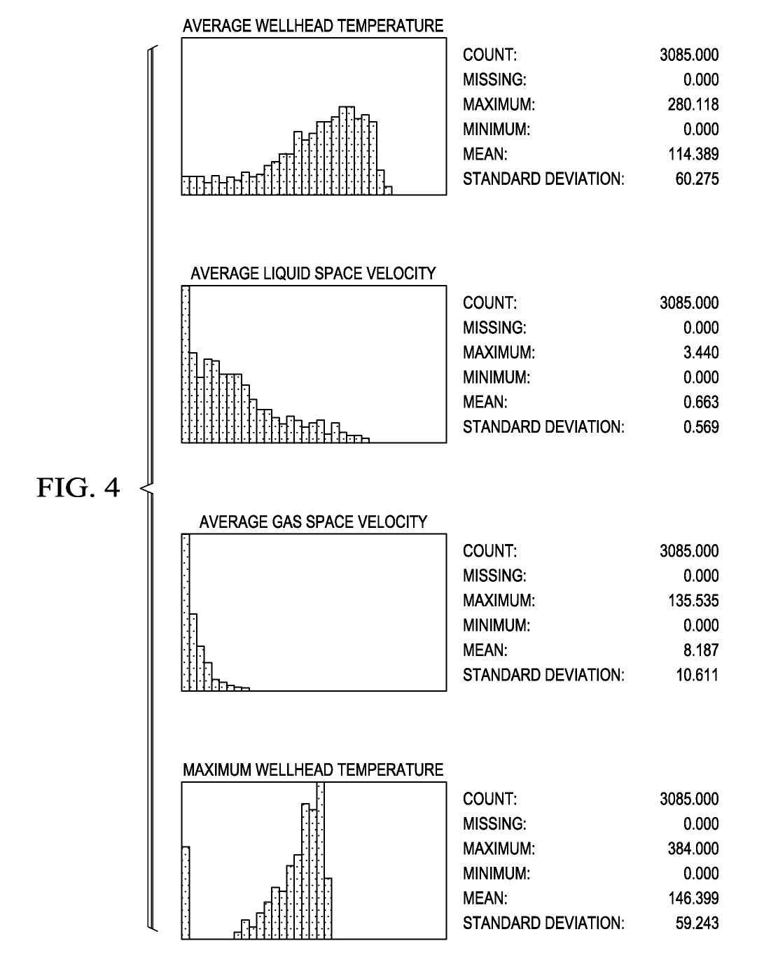

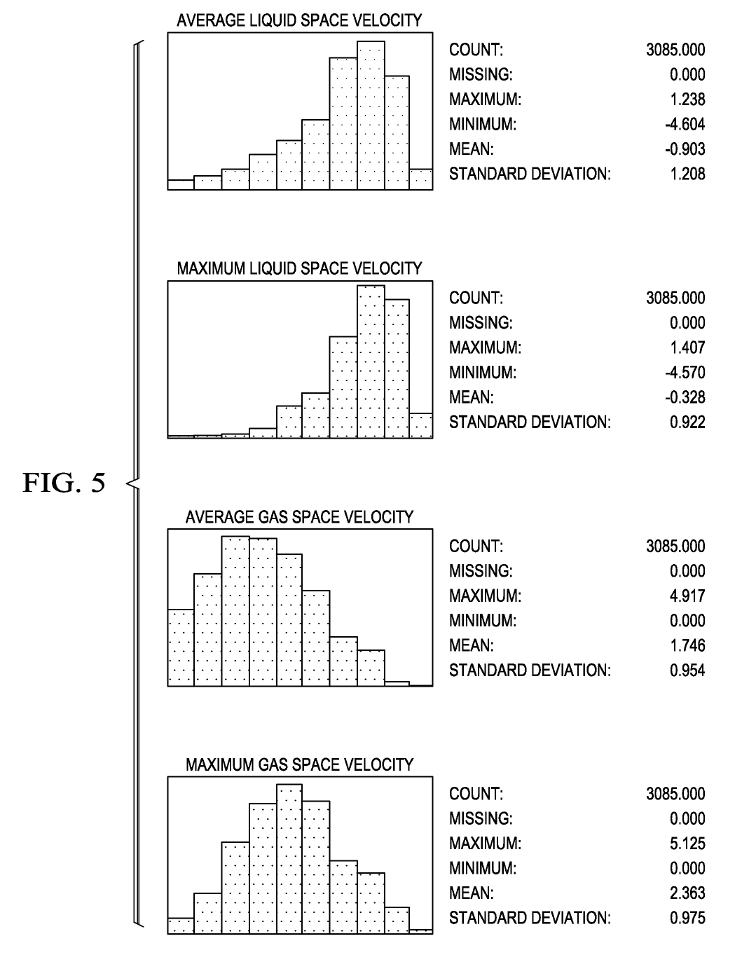

One or more types of statistical variables can be added to the data. For example, depending on the type of predictive model being created and used, an average, a maximum, and a standard deviation for each predictor can be used. Because the predictors are all generally positively skewed, the inter-quartile range (IQR) can be used instead of a standard deviation, where IQR=Q3−Q1 is the first (Q1) and third (Q3) quartiles for trimmed data for each predictor. In some instances, logarithms can be used for one or more of the predictors to make the respective distributions less skewed. The use of logarithms can be determined by examining a histogram for each predictor. For example, predictors including average wellhead temperature, liquid space velocity (Av_liquid), gas space velocity (Av_gasvel) and maximum wellhead temperature can be used because their respective distribution exhibit some degree of skew, as shown in FIG. 4. Distributions without a high positive skew value, such as wellhead temperatures variables, may not require logarithms. When logarithms are used for the averages, they can also be used for the maximums. Logarithms can also be used for all IQR values. The resulting distributions for the average and maximum for liquid and gas velocity are shown in FIG. 5.

The data that is prepared can be augmented with indicators for one or more categorical variables, and then fit to a mathematical model, such as a neural network model, to find a best-fitting model for the set of variables or predictors that has been selected. The effects of the variables in the neural network model can be used to make predictions for coupons that have not been pulled.

The dataset can include a number of categorical (indicator) variables and can include a descriptive name of the reservoir served by the pipeline, such as padname (SDI or MPI, designated pSDI), well subset (a well grouping around time of installation (wYear1, wYear2, . . . ), first treatment (a well grouping around the year of first chemical inhibition treatment (treat. - - - ), gas-lifted well (categorization of wells which always has gas lift), drive, zones (categorization of how many different production zones were used in a well), metallurgy (a categorization by different metallurgy for the well lines), treatment intensity (a categorization of the extent of chemical inhibition addition), role varied (an indicator that the well was not always just a production well) and production zone (a categorization of the subsurface zone from which the well produced).

Categorical variables can be represented as a numerical variable. For example, the categorical variable for pad name can be represented as: pSDI=1 if the pad is SDI and 0 if the pad is MPI so that one variable can represent two pads. Multiple classes within a category can be similarly represented. For example, classifications of treatment intensity, which can include low, moderate and high can be represented as two numerical variables, such as treat.-intens.low=1 if the treatment intensity is low or 0 if the treatment intensity is moderate or high, and treat.intens.high=1 if the treatment intensity is high or 0 if the treatment intensity is low or moderate. Then when both of these indicator variables are 0, the situation where the treatment intensity is moderate is numerically and uniquely specified.

There can be a plurality of types of quantitative predictors. First, there are predictors for which (trimmed) statistics can be computed for each coupon period: oil production, gas production, water production, lift gas, wellhead temperature (WHT), wellhead pressure (WHP), liquid space velocity (vsl) and gas space velocity (vsg). As noted above, the statistics that are used for developing the coupon corrosion rate prediction model can be the average, maximum and IQR for the trimmed data. In addition, other predictors can be used to represent the periods during which the coupons are being used in the pipeline. Some of these can be simply quantities that may not available on a daily basis. For example, they can be estimated CO₂, time since the last inhibition treatment (newdelaycalc), number of shut-ins for the well, duration of time in which the coupon was in the pipeline, percentage of working hours for the well. Lastly there are some quantitative variables that can be used in attempts to capture the well-to-well differences including the cumulative oil production across the life of the well, the cumulative gas production across the life of the well, the cumulative water production across the life of the well and the cumulative lift gas used across the life of the well.

In some aspects, all the data that is collected can be used in the modeling to verify the ongoing effectiveness of the protective barriers. In some cases, a family of pipelines can exhibit behavior that is sufficiently well aligned that it can be used to draw valid inferences about the ongoing corrosion activity of any member of that family of pipelines pending the next inspection of that pipeline.

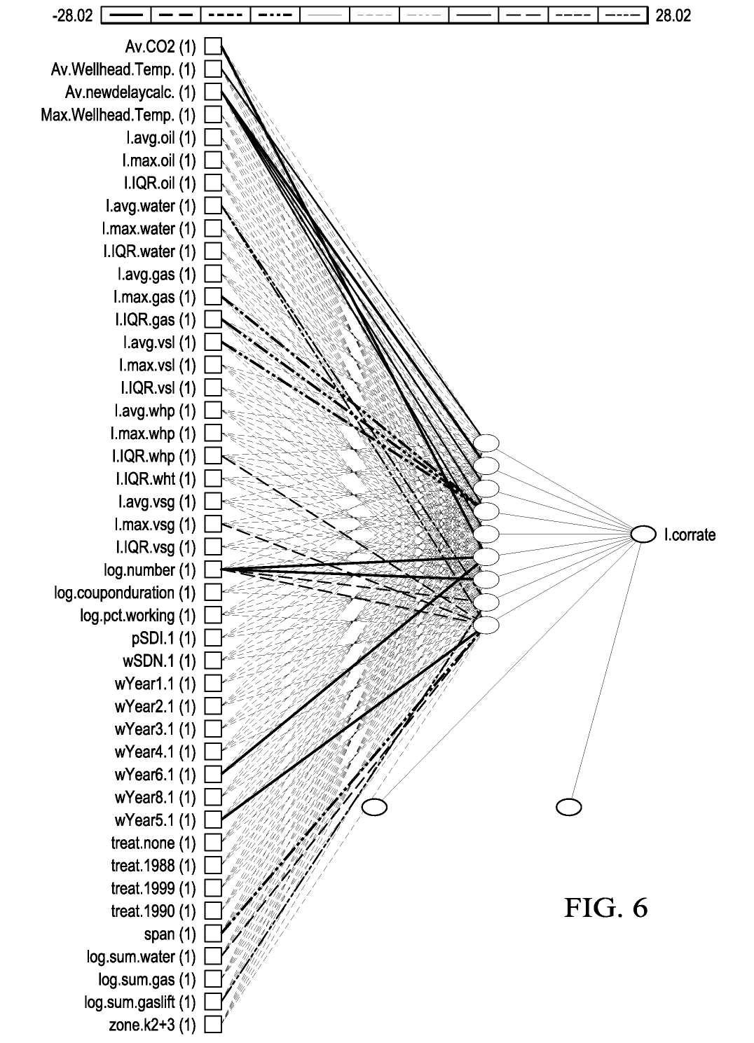

Returning to FIG. 3, once the data is prepared, the data can then be used to create a numerical model, such as a neural network, to estimate the corrosion activity of coupons within the pipeline at 310. For example, the neural network can be a multi-layer perceptron (MLP), which can be represented as a nonlinear prediction equation. The neural network has an input node for each of the predictors in the neural network equation. Each of the input nodes can be connected to each of the hidden nodes by a weight. The number of hidden nodes can be specified as a control parameter. By way of a non-limiting example, the corrosion rate model can have 44 inputs and 9 nodes, which results in 396 weights that need to be estimated from the data. There is a constant, which is similar to the intercept in fitting a straight line that connects to the output node, as shown in FIG. 6. Although the description uses neural networks as examples of the numerical model, other types of modeling such as a linear regression or logistic regression algorithm may also be used as would be apparent.

In developing the model, a portion of the data can be saved for testing the neural network that has been fitted to the training data. In the examples below, 30% of the data was reserved to test the neural network model. This data can be chosen randomly, however, in the examples below, more of the testing data was chosen from more recent coupons because the predictive coupon model is for making inferences for future applications. However, more or less than 30% of the data can be reserved as would be apparent.

The neural network modeling can operate using numerical optimization, which begins from an initial set of random weights, for example 406 values, and proceeds to an optimum set of weights through an iterative process that minimizes the sum of the squared errors for the differences between the observed log (corrosion rates) and the values estimated by the neural network. The mean square that is minimized can be the mean square for the test data, randomly selected from the data that is used by the neural network for fitting the data.

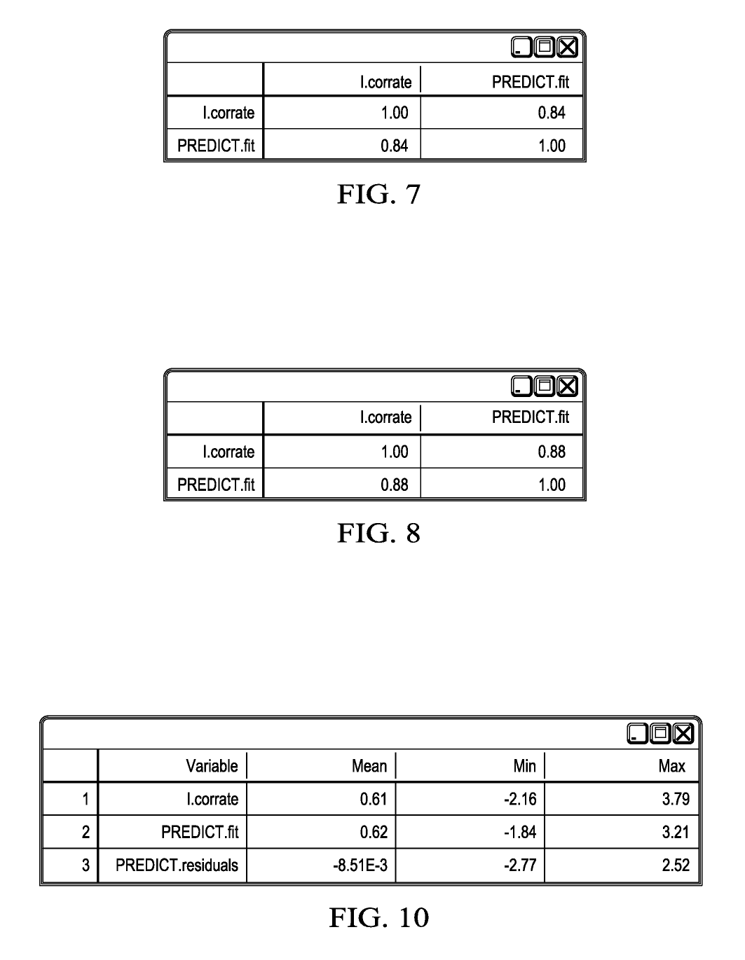

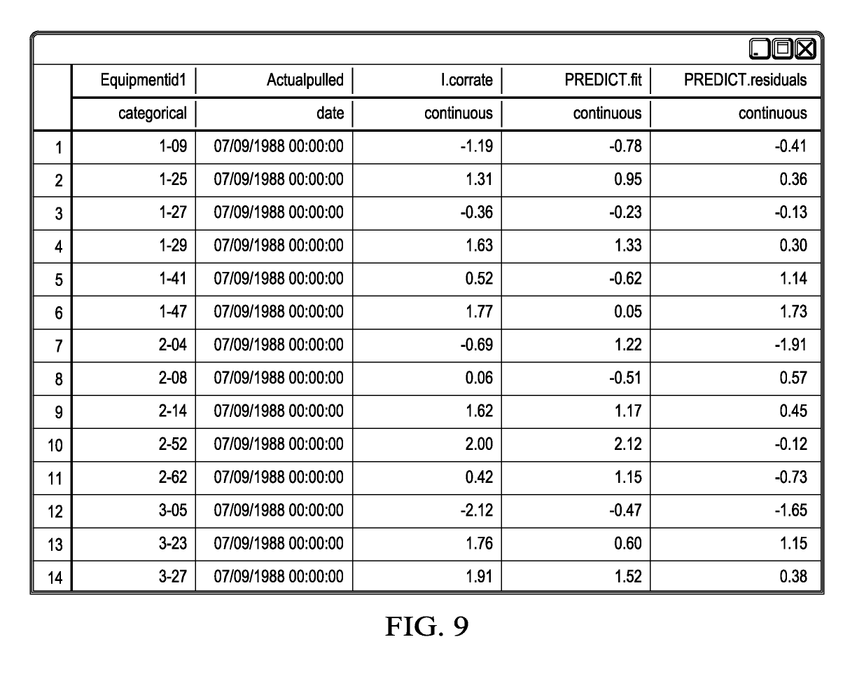

The objective in fitting the neural network can be to develop a good predictor, which is the one which has the largest correlation between the actual log (corrosion rate) values and the calculated log (corrosion rate) values for the validation data. As with any regression equation, the neural network can represent a mean value for all realizations at a specified set of inputs, where the minimum value for the data (I.corrate) can be less than the minimum value for the fitted equation (PREDICT.fit) and similarly the maximum value for the data can be greater than the maximum value for the fitted equation. FIG. 7 shows an exemplary table listing the expected correlations from the training data for the neural network model and FIG. 8 shows an exemplary table listing the expected correlations from the validation data (I.corrate) for the neural network model. FIG. 9 shows a partial exemplary table listing for the set of predictions that are made for the observed data (I.corrage) and FIG. 10 shows an exemplary table listing the statistics for a validation set. As with any regression equation, the neural network can represent a mean value for all realizations at a specified set of inputs. Then the minimum value for the data (l.corrate) can be less than the minimum value for the fitted equation (PREDICT.fit), and similarly for the maximum value.

Returning again to FIG. 3, once the statistical or computational model is created, the model can be further refined at 315. The neural network will tend to yield the best results when used with the predictors having the most importance for the model. First, predictors can be varied across its range while the median value is used for all the other predictors. However, there can be difficulties with this approach, because some of these predictors can be categorical variables, which means that they can be represented in the model with predictors that take only 0 and 1 as their values. The average value across the data for one of these (0,1) predictors results in a nonsensical number between 0 and 1. Second, all of the predictors can be highly pairwise correlated. There are two types of correlation, wherein one uses means, maximum and IQR's, especially for trimmed data, which can create some intrinsic predictor correlations that are unavoidable.

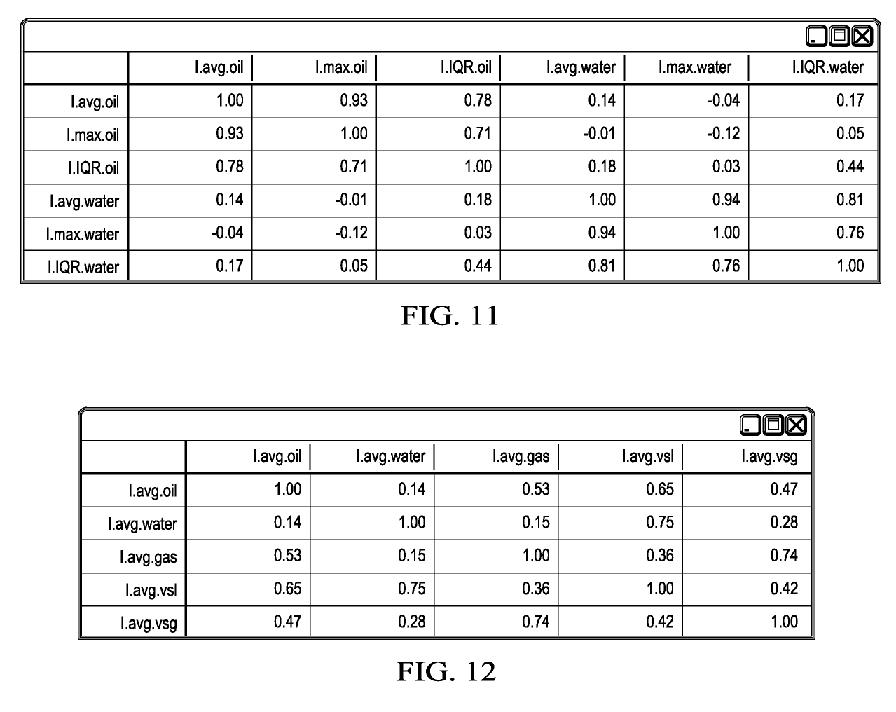

By way of a non-limiting example, FIG. 11 shows an exemplary table listing the relationship (correlation) between the mean, maximum and IQR for oil and water predictors. As shown in the table, the correlations for oil all exceed 0.7, and the maximum is 0.93. The correlations for water all exceed 0.75, and the maximum is 0.94. For either predictor, looking at the effect of the average oil value or average water value in a neural network model by varying the average across its range while holding the maximum and IQR values fixed at any value would result in a lot of nonsensical computations.

FIG. 12 shows an exemplary table listing the relationship (correlation) between oil, water, space velocity for the liquid (vsl), gas and space velocity of the gas (vsg) predictors. As shown in the table, there can also be some correlations between the predictors. Here oil and water can correlate with the space velocity for the liquid (vsl) and gas can correlate with the space velocity of the gas (vsg). Again, calculating values for gas across its range for a constant value of vsg would not be a sensible approach. Note, however, that there is no significant correlation between oil and water. Because the largest correlations between predictors, such as gas and vsg, can be smaller than the largest correlations within predictors in the previous table, the predictors can be ranked with a simple linear regression. A linear regression can be fitted to the predictors used in the neural network above. However, the linear regression for fitting training data result in a correlation of 0.75 between the actual log (corrosion rate) values and the fitted values, while the neural network for the same set of predictors has a correlation of 0.88. This difference occurs because of the nonlinearity in the relationships between predictors and the response, which will be discussed more fully below.

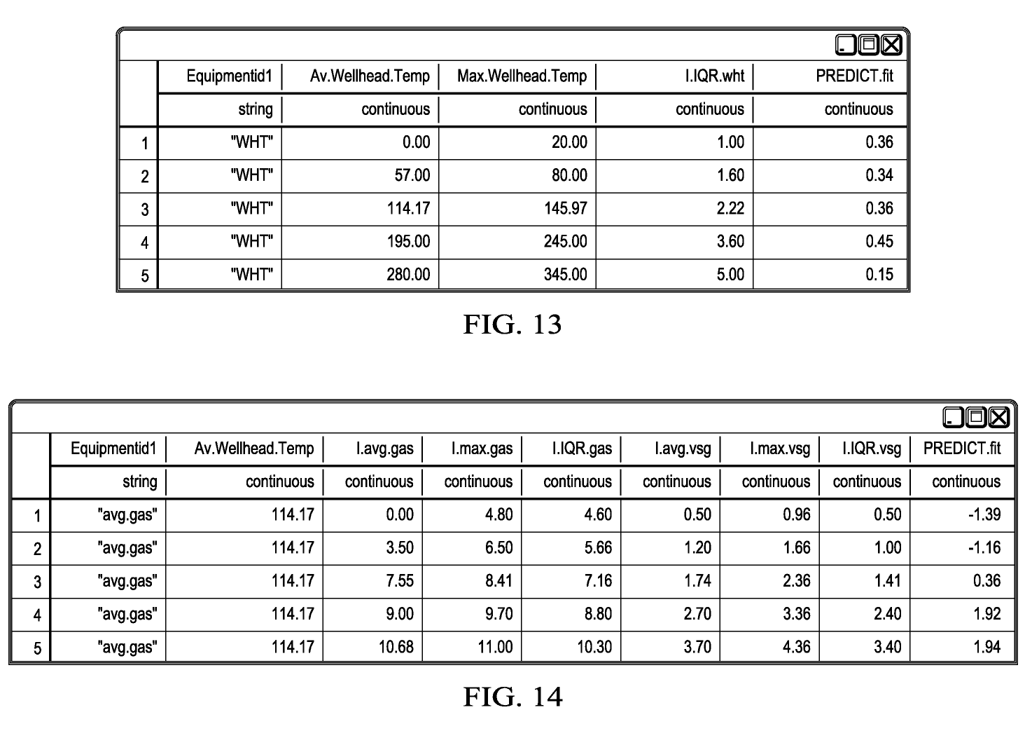

To determine a ranking of the predictor effects, the usual procedure for a neural network, varying one predictor while holding all the other predictors at a center value can be taken as the starting point. Additionally or alternatively, modifications to this approach can be made including varying the maximums and the IQR's in concert with the average values, as shown in FIG. 13 for WHT and varying the maximums and IQR's where other predictors can be correlated with a specific predictor, as shown in FIG. 14 for gas and vsg.

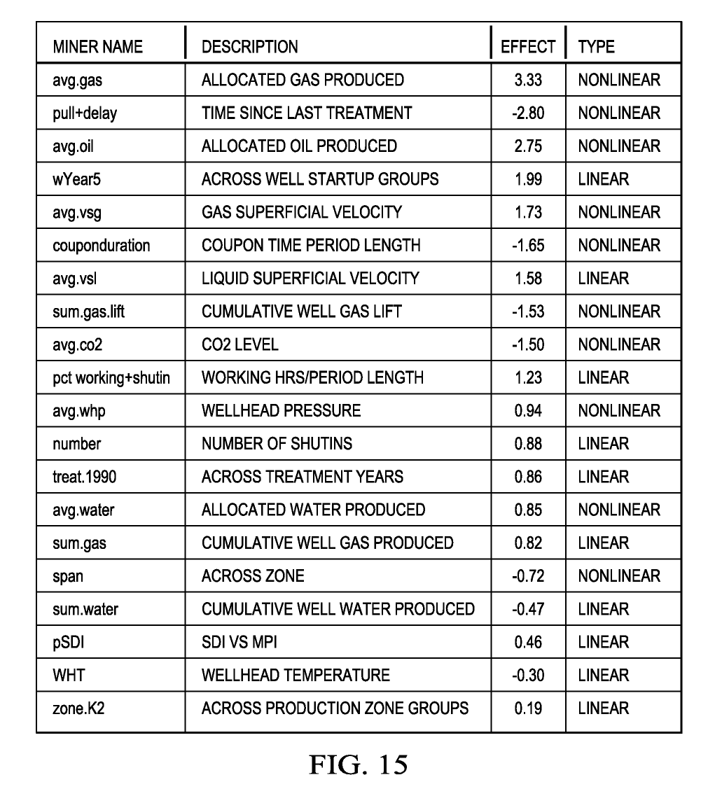

A data set can be created for each of the predictors. Each predictor in the complete set of predictors can have a set of data points that are included to describe the effect for that predictor. The importance of the predictors in determining the corrosion or pitting rate can be analyzed. In FIGS. 13 and 14, the last column shows the prediction when all other predictors in the neural network have been set to their average values. The “effect” score of the predictor across it range is then the difference between the largest and the smallest PREDICT.fit value, here 0.30 (=0.45−0.15) for WHT and 3.33 (=1.94−(−1.39)) for gas produced. The entire set of effects can be accumulated as shown in FIG. 15.

In this example, the largest effect is found to be average gas produced, where higher values result in a positive contribution to corrosion rate determination. The time slice of the last chemical treatment is second on the list and has a negative effect, which seems counter-intuitive. However, the data used to determine these effects did not result from controlled experiments. The effect is negative because chemicals are added when the corrosion rate was high and are not needed when the corrosion rate is low. One can continue in the same vein for treatment rankings, which shows a similar counter-intuitive effect for coupon duration, the time that the coupon was in the pipeline. Generally coupons are pulled more quickly when corrosion is expected and left installed longer when lesser corrosion is anticipated.

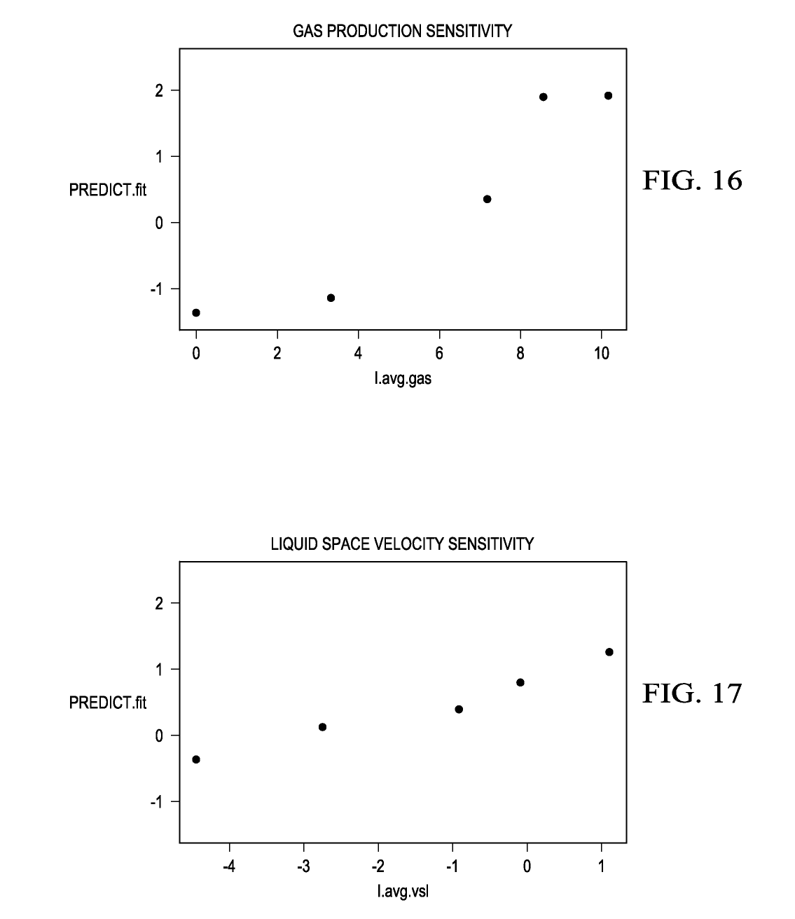

The linear and nonlinear effects are categorized in FIG. 15 according to the type of effect from moving across the range of values for a predictor. Nominally a neural network is a nonlinear model. However, as in a polynomial regression equation, not all variables which could be represented by nonlinear effects actually can have nonlinear effects. The predictors with the most importance can have significant nonlinearity. FIG. 16 shows a plot below for gas production. For example, the liquid space velocity (vsl) is an example of a predictor whose effect is linear. FIG. 17 shows a plot, which has the same ordinate scale as FIG. 16, where the effect of vsl across its range is considerably smaller than the effect of gas production.

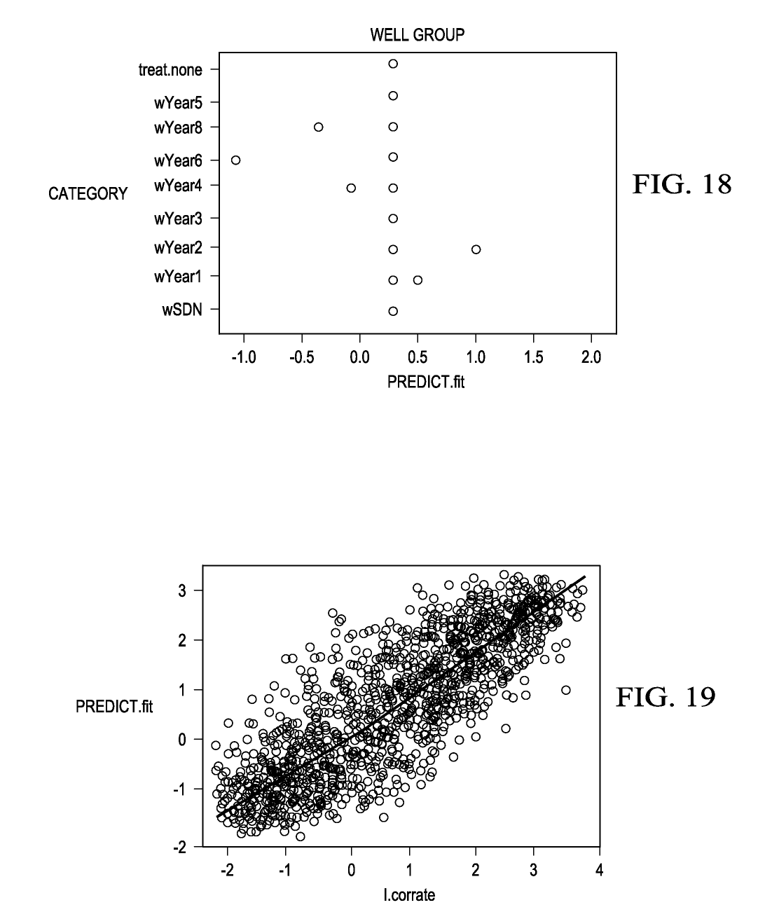

In this example, the grouping of wells by their year of first production was one of the categorical predictors retained as an important predictor in the neural network. FIG. 18 shows a display which displays the effects of the different well groups, which are listed on the vertical axis of the plot. The vertical bar in the middle of the plot is the average contribution to the neural network for all of the well groups. Note that wells in some groups, such as wYear2, had a more corrosive effect on coupons, while wells in other groups, particularly wYear6, have a much less corrosive effect. As shown in both the FIGS. 15 and 18 the well group had less effect on corrosion than gas production but more effect than vsl.

As the model is refined, the number and type of predictors can be reduced or eliminated to ensure that the model is no more complicated than necessary, but is robust enough to produce predictable results that have a high degree of accuracy and reliability. For example, predictors that rank lower in relevance to the determination of corrosion rates and/or pitting rates can be excluded from the model without loss of accuracy and reliability. For example, deletions can be made for predictors having effect values less than 0.2. In some instances, entire groups of categorical predictors can be dropped depending on their respective effect on the corrosion predictive ability.

This inexactness can be due to the predictor correlations. There can be different weightings on the average, maximum and IQR for allocated oil produced, for example, that might not change the fit to the responses very much. Likewise, across variables, the same type of situation prevails. Most variables have some intrinsic overlap, such as allocated gas produced and the space velocity for gas, which was shown previously. Nominally, the weights and even the predictors that are used do not have any explicit role in the value of the model. The model can be a computational device for log (corrosion rate) and the neural network fitting can be based on test data that is fitted by a model which is estimated from training data.

The model can be evaluated based on the particular set of predictors chosen because the intent of the model is to explain all the variability in the coupon average for each well and each coupon period except for the portion that can be attributable to noise from an accumulation of individually inconsequential and generally unknown drivers. The model should not be biased versus any factor that could be represented by quantitative or categorical measurements.

Returning again to FIG. 3, once the computational model is refined, the model can be used to make predictions at 320. The primary statistic that is available for neural network can be the residual difference: Residual=log (corrosion rate)−[neural network computed value]. This can be the observed response value minus the calculated value from the equation that has been fitted to the data. Though it is a computational device, the neural network can be actually expressed as a nonlinear equation that computes log (corrosion rate) from values for predictors.

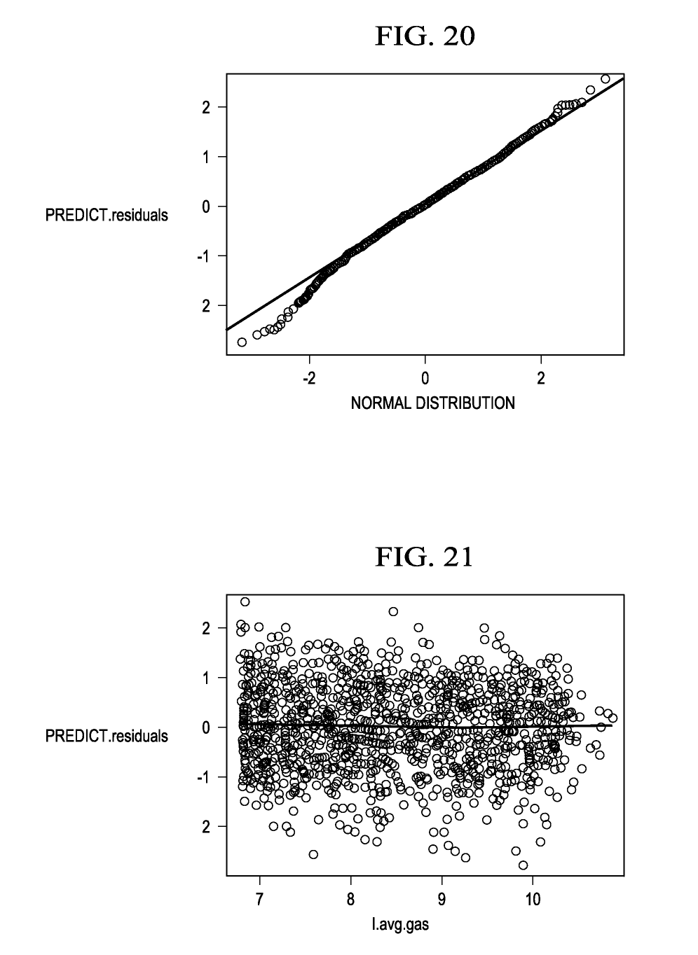

FIG. 19 shows an exemplary plot of the actual responses, log (corrosion rate) values, “I.correlate” versus the model's calculated values, “PREDICT.fit”, for the same data point, shown for the training data. The line in the plot is a LOESS (low order exponential smoothing) line. Characteristics of this line are: plotted points cluster about the line mostly linearly, some data values smaller than any model values and some data values larger than any model values. The general clustering reflects the correlation of 0.88 between the two quantities. Because the model is a mean value for a specific combination of inputs, it is generally not capable of predicting as large as the largest values or as small as the smallest values. Generally, it is not apparent that any of the 2219 data points is inconsistent versus the other data points. This can be seen more readily from the Q-Q plot versus a normal distribution shown in FIG. 20.

If multiple regression equations are used for the model, the points in the normal Q-Q plot can be approximately a straight line. The normal distribution of residual differences can be a necessary assumption that needs to be validated in multiple regressions. There are no statistical assumptions for neural networks. The essentially linear effect of the Q-Q plot can be a desirable objective in neural networks modeling. In fact, it was caused to occur by using log (corrosion rate) as the metric instead of the actual corrosion rate data. Without the logs, attempts at accurately predicting the large values for corrosion rate would dominate the adjustment of weights in the neural network. The logarithm can achieve a more balanced fit to the corrosion rate data that should effectively predict when corrosion rates will be large.

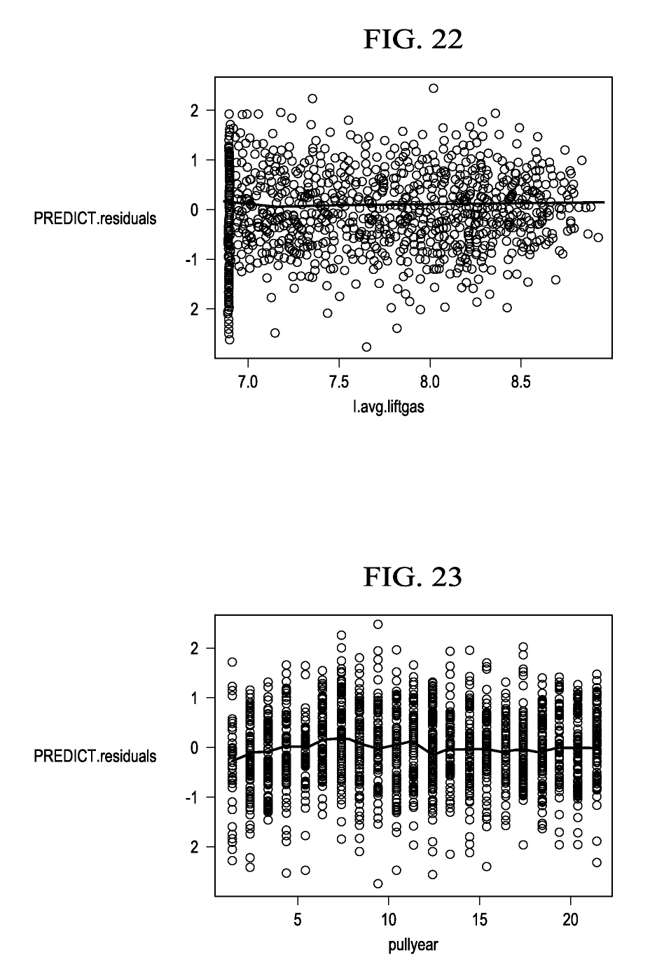

Generally, one strives to have no bias for the residual differences versus any of the predictors or the candidate predictors that were excluded from the equation. FIG. 21 shows a plot for the residuals versus the gas production values for the training data. The plotted points scatter very uniformly across the range of the average gas values, and the LOWESS line is nearly straight around the zero residual value. A check can be made for predictors that were excluded, such as lift gas, using similar plots, as shown in FIG. 22, which shows that there is no bias for the residuals versus average lift gas for a coupon period. So the decision to exclude this predictor completely from the corrosion rate prediction model appears to be validated.

In this example, as the model was developed, earlier models showed a definite bias for the year to which the coupon was pulled. This led to the inclusion of a number of different variables that concerned the first production, the production zones, and the use of inhibition, which occurred in the late 1980's and early 1990's. FIG. 23 shows a plot of the residuals versus the production year shows no bias, so the totality of all the additions and also deletions for the predictor set affected the necessary result for the residuals versus the year that the coupon was pulled.

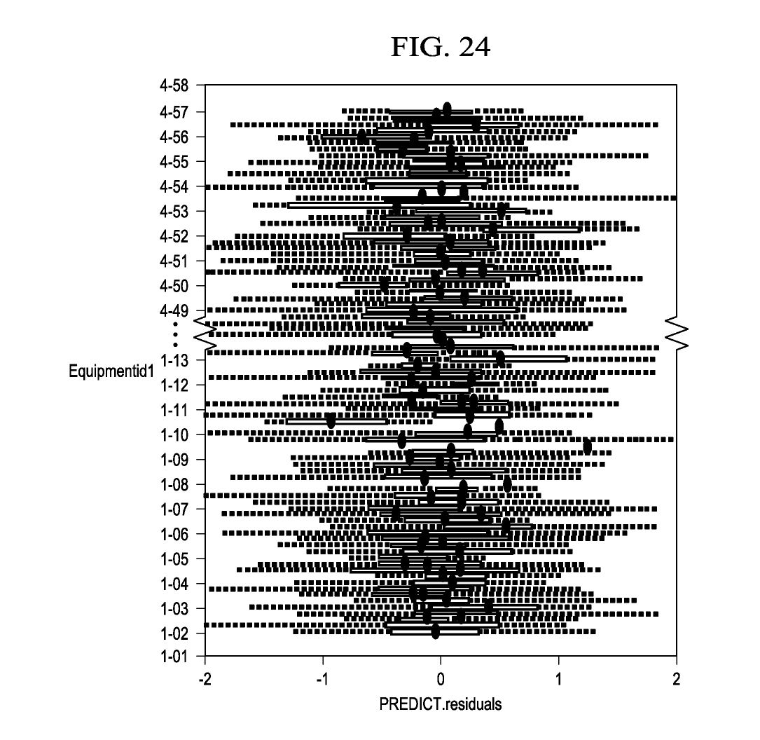

Another identifier for the coupon that led to the addition of variables that related to the production zone and first production for the wells was the actual designation of the well. Again, early models showed that there was a bias to the residuals versus well identification. FIG. 24 shows a plot of the residuals versus the well identification code. In this example, there are 85 different well lines for which coupon, production, installation and subsurface description data are available. One would expect the well medians, the black dots in the pictures, to have a normal distribution, because these are means or medians for symmetric distributions, the presumed result for residuals for corrosion rates once the logarithmic transformation is applied. In a normal distribution for the logarithms, a couple of somewhat larger values are simply the members of the tails of the distribution.

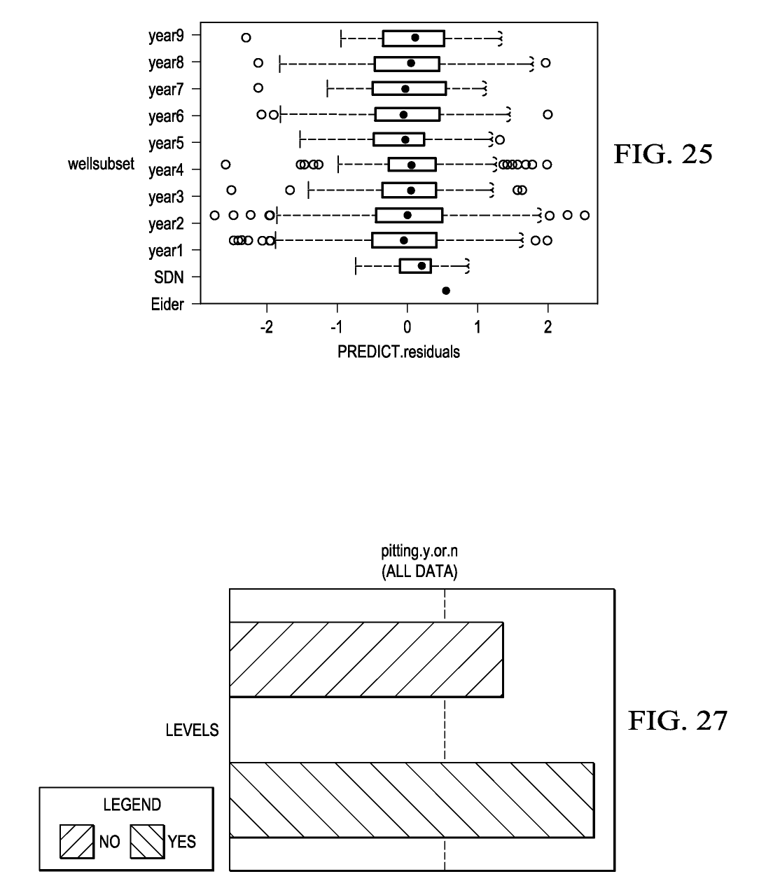

Another approach to assessing the efficacy of the accountability for well differences can be done by using well groupings. As described above, 8 different predictors are used to describe the 11 well groups. Predictors are used for all groups for which there are sufficient numbers of coupon occurrences in the groups. The table of significant effects shows that the well groupings was 4^{th} most important in the list of predictor groups. Then the plot of the residuals of the 85 wells in their 11 groups as shown in FIG. 25 would not be expected to have a bias versus the well group. Because the well group is a further averaging of the residuals for the wells, one expects the averages for the well groups to cluster more closely about zero. In fact there is very little difference among the averages for the well groups, except for Eider, for which either coupons or production information was missing for almost all coupon pull periods.

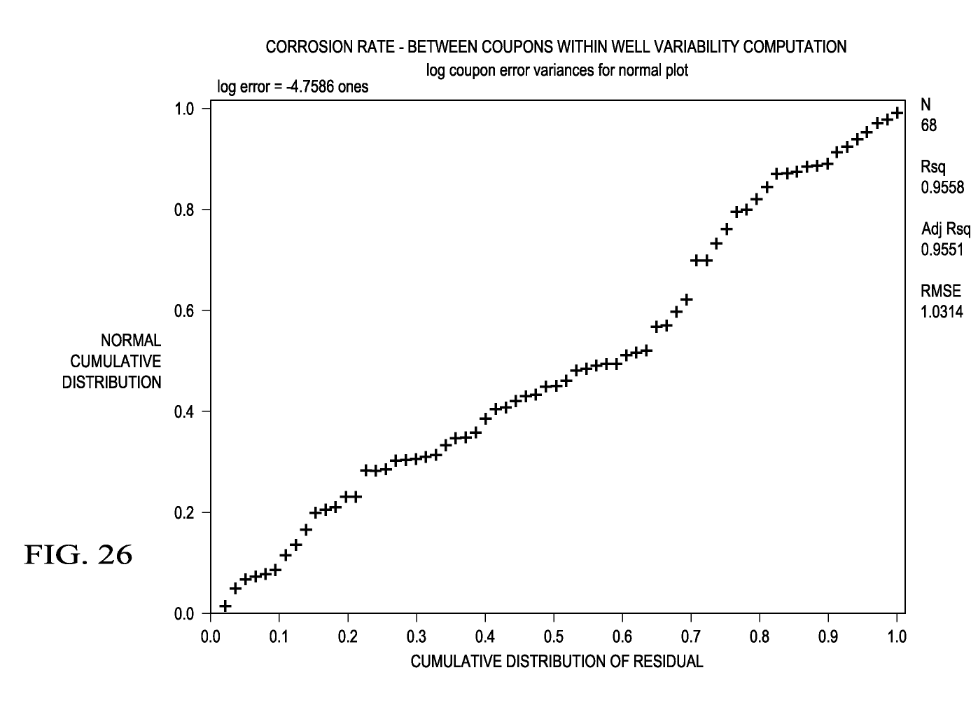

In order to have a degree of confidence in the predictability of the model, good corrosion rate data from the coupons can be needed to have any hope of creating an effective predictive capability. This can be facilitated by using duplicate coupons. The predictive modeling can be done with the averages of the coupons, because the between coupon variability is independent of any of the predictors. It would depend on coupon differences as installed, which presumably would be identical, and variability in the measurement laboratory. The ratio for the variability between the coupon periods could be large because there can be variations between-coupon variability (because of the effects of production) or because the variability is small for the coupon pairs. In fact, statistical theory can be used to contend that these within-coupon variances should be normally distributed as a group, which is verified by the essentially straight line of these variances plotted on a normal probability axis, as shown in FIG. 26.

A numerical model can also be used to predict pitting of the coupons. FIG. 27 shows a plot of the number of coupons that have pitting, where again an observation is the average of the two coupons that are inserted simultaneously. As shown in the figure, 43% of the coupons are found to have no pitting (lighter bar). Quantitatively this literally means that the pitting rate is zero. It is typically difficult to create a quantitative model for pitting that will give zero for 43% of the time. For pitting, a two step approach can be used for the modeling. First, a classification model can be developed that calculates the probability that there will be pitting. If the probably is large enough, which usually means that it exceeds 0.5, then the decision that there will be pitting can be made. Once it has been ascertained that there will be pitting, then a pitting rate can be estimated by a second model.

The pitting modeling process can also be done using neural networks, except that these neural networks are trying to correctly classify each coupon as Yes or No for pitting using the same set of inputs used for predicting the corrosion rate. For example, a 5-node neural network can be used to provide adequate classification capability without over-fitting versus the training data. As with the corrosion rate prediction model described above, other node configurations and other modeling algorithms can be used as would be apparent.

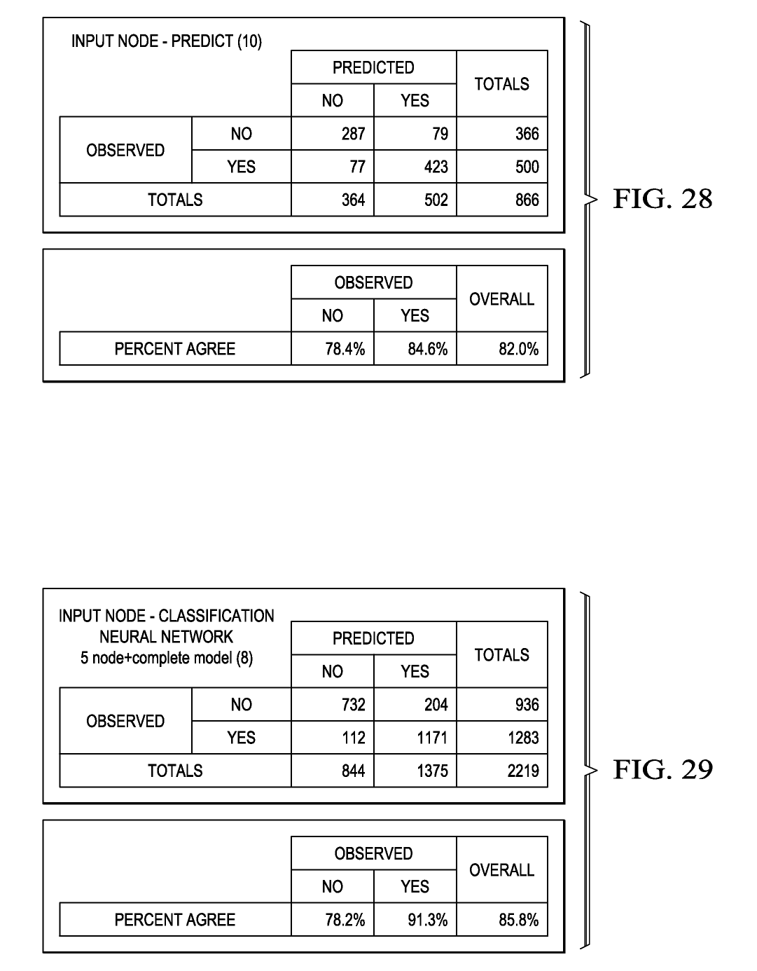

FIG. 28 shows a table for validation data, where 82% of the pitting rate occurrences have been correctly classified. A higher error rate for false positives was allowed, because it would be more important to find pitting, when it is occurring, than to verify that there is no pitting when none is occurring. All classification processes have some error rate. Here the overall error rate was 18%.

As with fitting the corrosion rate data, accuracy is somewhat better for the data that is actually used for calibrating the neural network, as shown in FIG. 29, where 91% of the fitting data can be correctly classified for pitting occurrence, though the false positive rate can be identical.

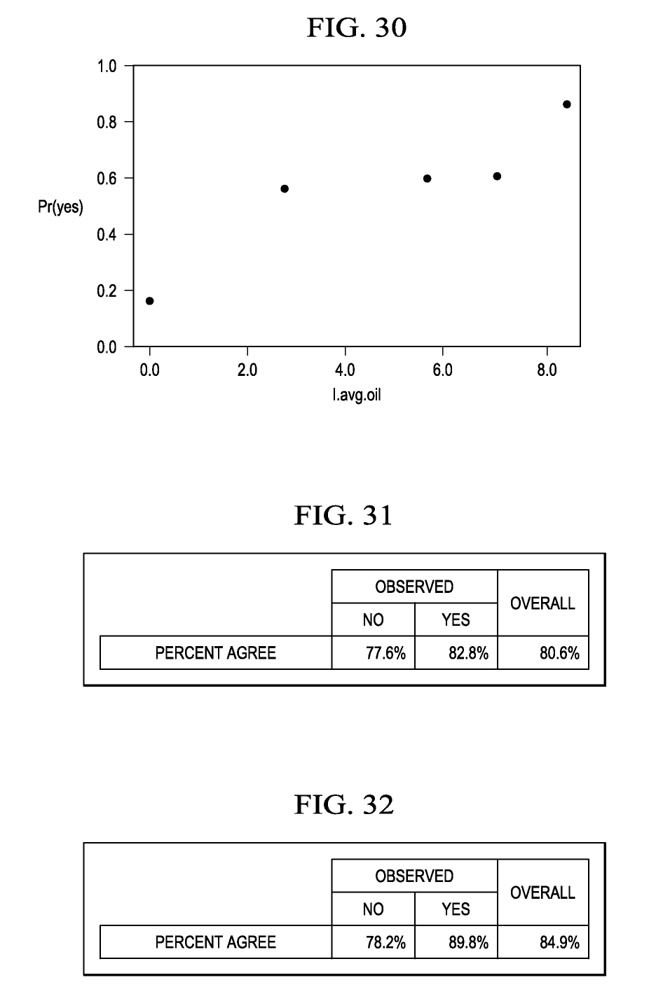

One can follow a similar exercise to determine the effects of the inputs on the classification. For example, FIG. 30 shows a plot of the impact of oil production, which had the biggest effect on the probability of a “yes” classification for pitting. Here, importance means the impact on a calculated probability. No pitting occurs at very low levels of oil production. Pitting can be highly likely at high levels of oil production.

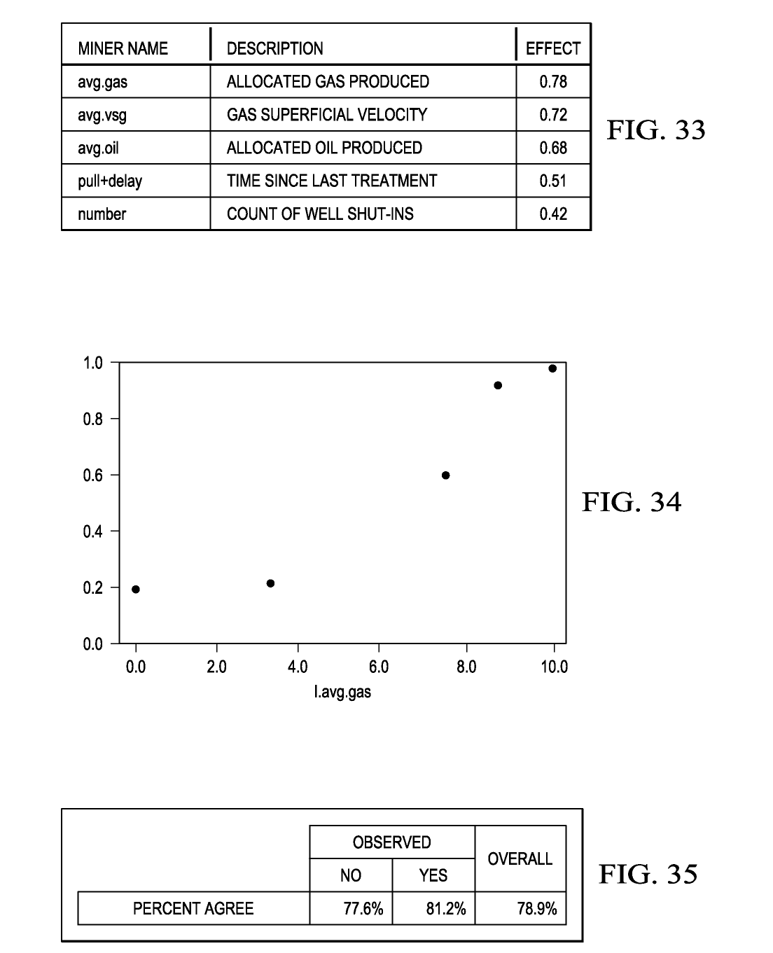

Some of the predictors did not have a lot of impact on classification for the occurrence of pitting, so there is a reduction in the number of predictors and a refitting of the models. FIG. 31 shows a table of results for fitting the validation data, where there can be a small loss in predictability because of the simplification of the model. FIG. 32 shows a table with a similar small loss in predictability across the data that was used for fitting the neural network model. The reduced model used only 47 input nodes, while the original model had 61 input nodes. Actually the number of neural network coefficients increases, because the number of nodes for the neural network increased from 5 to 7. The reduced model should work better for prediction. FIG. 33 shows a table of the impact of the predictors on the classification for the reduced neural network equation. Eliminating redundancy in variables reduction results in the first four predictors also being in the top 5 predictors from the corrosion rate prediction model, which perhaps should be expected. FIG. 34 shows a plot for the effect of gas production.

As with oil production, higher allocated gas production also correlates with increased likelihood of pitting. Predictions can similarly be made for pitting for new coupon results in the same way that predictions are made above for corrosion rate. The additional coupons collected subsequent to the modeling are classified for pitting as shown in FIG. 35. This is essentially the same result that was obtained for the validation data above, which certainly indicates that the classification model is reasonable for use as a predictor.

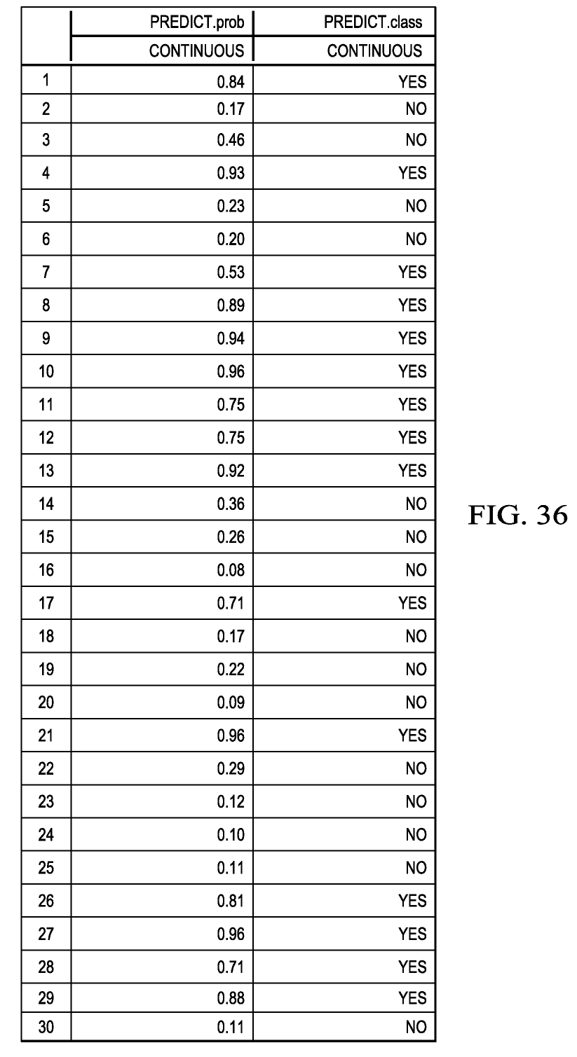

The decision about the occurrences or not of pitting can also be made for the virtual or soft coupon, the predictive coupon corrosion rate that was discussed above. FIG. 36 shows a table of predictions produced for the data for which the production data was assimilated, as discussed previously for the corrosion rate.

If there is pitting, then there is a pitting rate. For the data for which there is pitting, the modeling process used for corrosion rates can be repeated in its entirety. A two-step predictive process can be used in which the decision about pitting is made, and, if the decision is positive, i.e., where it is yes for the table above, then the pitting rate can be calculated.

While the present disclosure has been described according to its preferred embodiments, it is of course contemplated that modifications of, and alternatives to these embodiments, such modifications and alternatives obtaining the advantages and benefits of this disclosure, will be apparent to those of ordinary skill in the art having reference to this specification and its drawings. It is contemplated that such modifications and alternatives are within the scope of this disclosure as subsequently claimed herein.

What is claimed is:

1. A computer-implemented method for predicting a material deterioration of a coupon inserted into the well line system, comprising:
receiving data related to the well line system; and
predicting, by a processor, the material deterioration of the coupon inserted into the well line system based on a mathematical model of material deterioration using one or more predictors.

2. The computer-implemented method according to claim 1, further comprising creating the mathematical model of material deterioration using the one or more predictors.

3. The computer-implemented method according to claim 1, wherein the mathematical model includes a logistic regression or a neural network.

4. The computer-implemented method according to claim 1, wherein the predictions are based on production conditions, historical results and well characteristics for a particular pipeline that is being evaluated by the coupons.

5. The computer-implemented method according to claim 1, wherein the predictions can be made periodically or continuously.

6. The computer-implemented method according to claim 1, further comprising causing the one or more processors to fit the mathematical model to determine a best-fitting model for the one or more predictors.

7. The computer-implemented method according to claim 1, wherein the data includes one or more categorical and/or one or more numerical variables.

8. The computer-implemented method according to claim 7, wherein the categorical variables include a pad name, a well subset, a date of first inhibition treatment, gas-lifted well information, reservoir drive, zones, metallurgy, a treatment intensity, and a production zone.

9. The computer-implemented method according to claim 1, wherein the data includes quantitative predictors.

10. The computer-implemented method according to claim 9, wherein the quantitative predictors include predictors computed for each coupon period including oil production, gas production, water production, a lift gas, a wellhead temperature, a wellhead pressure, a liquid space velocity and a gas space velocity.

11. The computer-implemented method according to claim 10, wherein the quantitative predictors include an average, a maximum and an inter-quartile range for the data.

12. The computer-implemented method according to claim 1, wherein the data includes predictors used to represent periods during which the coupon was being used in the pipeline including estimated CO₂, time since the last inhibition treatment, number of shut-ins for the well, duration of time in which the coupon was in the pipeline, and percentage of working hours for the well and fraction of the time on line.

13. The computer-implemented method according to claim 1, wherein the data includes quantitative variables representing well-to-well differences including the span of the operating time, the cumulative oil production across the life of the well, the cumulative gas production across the life of the well, the cumulative water production across the life of the well and the cumulative lift gas used across the life of the well.

14. The computer-implemented method according to claim 3, wherein the neural network includes a multi-layer perceptron.

15. The computer-implemented method according to claim 14, wherein the multi-layer perceptron includes a nonlinear prediction equation.

16. The computer-implemented method according to claim 1, wherein the one or more predictors are determined by determining a correlation between the data.

17. The computer-implemented method according to claim 17, wherein the one or more predictors are determined if the correlation is greater than a correlation threshold.

18. The computer-implemented method according to claim 1, wherein the one or more predictors of material deterioration of the coupon are based on the historical and current data.

19. The computer-implemented method according to claim 1, further comprising updating the mathematical model using updated data to produce an updated prediction of the material deterioration.

20. The computer-implemented method according to claim 1, wherein the material deterioration comprises corrosion rate, pit depth and/or pitting rate.

21. A prediction system for predicting a material deterioration of a coupon inserted into a well line system, comprising:
one or more central processing units for executing program instructions; and
a memory, coupled to the central processing unit, for storing a computer program including program instructions that, when executed by the one or more central processing units, is capable of causing the computer system to perform a sequence of operations for predicting a material deterioration of a coupon inserted into the well line system, the sequence of operations comprising:
receiving data related to the well line system; and
predicting a material deterioration of the coupon inserted into the well line system based on a computational model of the material deterioration using one or more predictors.

22. The prediction system according to claim 21, wherein the material deterioration comprises corrosion rate, pit depth and/or pitting rate.

23. A computer-readable medium storing a computer program that, when executed on a computer system, causes the computer system to perform a sequence of operations for predicting a material deterioration of a coupon inserted into the well line system, the sequence of operations comprising:
receiving data related to the well line system; and
predicting the deterioration of a coupon inserted into the well line system based on a computational model of corrosion activity using one or more predictors of the material deterioration.

24. The computer-readable medium according to claim 23, wherein the material deterioration comprises corrosion rate, pit depth and/or pitting rate.

25. A computer-implemented method for predicting a material deterioration of a coupon inserted into the well line system, comprising:
receiving data related to current and historical conditions of the well line system;
predicting, by a processor, the material deterioration of the coupon inserted into the well line system based on a mathematical model of material deterioration using one or more predictors; and
removing and inspecting the coupon at a determined time based on the material deterioration that was predicted.

26. The computer-implemented method according to claim 25, further comprising creating the mathematical model of material deterioration using the one or more predictors.

27. The computer-implemented method according to claim 25, wherein the mathematical model includes a logistic regression or a neural network.

28. The computer-implemented method according to claim 25, wherein the predictions are based on production conditions, historical results and well characteristics for a particular pipeline that is being evaluated by the coupons.

29. The computer-implemented method according to claim 25, wherein the predictions can be made periodically or continuously.

30. The computer-implemented method according to claim 25, further comprising causing the one or more processors to fit the mathematical model to determine a best-fitting model for the one or more predictors.

31. The computer-implemented method according to claim 25, wherein the data includes one or more categorical and/or one or more numerical variables.

32. The computer-implemented method according to claim 31, wherein the categorical variables include a pad name, a well subset, a date of first inhibition treatment, gas-lifted well information, reservoir drive, zones, metallurgy, a treatment intensity, and a production zone.

33. The computer-implemented method according to claim 25, wherein the data includes quantitative predictors.

34. The computer-implemented method according to claim 33, wherein the quantitative predictors include predictors computed for each coupon period including oil production, gas production, water production, a lift gas, a wellhead temperature, a wellhead pressure, a liquid space velocity and a gas space velocity.
